(19) United States
(12) Patent Application Publication
(10) Pub. No.: US 2024/0121612 A1
(43) Pub. Date: Apr. 11, 2024

(54) VISHING DEFENCE METHOD AND SYSTEM

(71) Applicant: Thandisizwe Ezwenilethu PAMA, Lonehill (ZA)

(72) Inventor: Thandisizwe Ezwenilethu PAMA, Lonehill (ZA)

(21) Appl. No.: 18/554,766

(22) PCT Filed: Mar. 11, 2022
(86) PCT No.: PCT/ZA2022/050013

§ 371 Date: Oct. 10, 2023

(30) Foreign Application Priority Data
Mar. 11, 2021 (ZA) 2021/01642

(51) Int. Cl. H04W 12/122; H04M 3/436

(52) U.S. Cl. CPC H04W 12/122; H04M 3/436; H04M 2203/6009; H04M 2203/6027

(57) ABSTRACT

A computer-implemented method of defending against vishing on mobile phones. The method comprises the steps of directing the mobile phone to treat each incoming call as a trigger to first determine the calling credentials (basically the phone number) of the incoming call. If the calling credentials cannot be determined or are otherwise suspect (basically numbers that do not appear in the mobile phone contact list), the mobile phone monitors for the occurrence of a predetermined vishing procedure, including processing of an OTP; processing a banking app in-app transaction; or voice, keypad or touch screen input of a number that matches a significant number previously stored in the mobile phone, such as a credit card or bank account number. If the execution of such a vishing procedure is detected, the mobile notifies the financial institution associated with the banking app to enable the implementation of appropriate vishing avoidance protocols.

### FIELD OF THE INVENTION

This invention relates to a method and means of defending against voice phishing or vishing cybercrime.

### BACKGROUND TO THE INVENTION

Voice phishing or vishing is the use of voice messaging and telephony in particular to conduct phishing attacks.

To cite but one example of a vishing scam, when the victim answers a vishing call, the caller, which could be a recording, alerts the victim that their credit card or bank account has experienced unusual or fraudulent activity. The call is typically used first to build trust between the fraudster and the victim and then to harvest additional details pertaining to the victim, such as a Personal Identification Number (PIN), card expiration date, date of birth, and more. And often the victim is instructed to perform one or more actions, including calling a specific phone number and/or entering a credit card or bank account number, PIN number or One Time Password (OTP). This enables the vishing fraudster to undertake fraudulent activity on the victim's financial accounts.

The term “phishing” describes activities that fraudsters use as “bait” to catch victims on the Internet. Today, the word is associated with social engineering-based scams—scams that try to manipulate people into falling into a trap. Phishing was originally restricted to text messaging, possibly because landline telephone services have traditionally been trustworthy, with services terminating in physical locations associated with known customers. Now however, phishing fraudsters have access to voice messaging functionality that has since been developed on Internet and mobile phone messaging platforms, which has given rise to vishing as a substantially more pernicious variant of phishing.

Like phishing, vishing attacks make use of social engineering techniques to manipulate people into performing actions or divulging confidential information, typically to allow the attacker to gain access to private personal and financial information for purposes of financial fraud. And, like phishing, in which cybercriminals use a message that appears to be from a trusted source, such as a bank employee, revenue service or law enforcement official, to name but one or two examples, vishing uses the same techniques. However, instead of using text messaging, such as an email, text, or direct-chat message, vishing techniques make use of voice-based Internet and mobile phone technologies that have the capacity to escape caller detection, for example by financial institutions and law enforcement agencies.

Voice-based Internet and mobile phone technologies also provide opportunities to almost industrialise vishing attacks by enabling fraudsters to place hundreds of vishing attack calls at a time and then to use interactive voice response (IVR) systems to operate as first responders in such mass attacks. Combined with, technologies like caller ID spoofing, voice-based Internet and mobile phone messaging platforms facilitate the task of fraudsters to automate vishing attacks and to create credible impressions that their information requests are from trusted individuals.

Vishing has unique attributes that separate the attack method from conventional phishing.

With the increased reach of mobile phones, vishing allows for the targeting of individuals, such as the elderly, who are familiar with phone technology and more prepared to develop trust in a caller during the course of a phone call. In addition, the prevalence of financial institutions and contact centers that ask for personal and confidential information, predisposes potential victims towards divulging sensitive information, with fraudsters exploiting the trust many people have while speaking to someone on the phone.

Another unique attribute of vishing attacks is the short duration of a typical vishing attack compared to conventional phishing, by way of email for example. Mobile phone users typically have immediate access to their phones, which means that vishing attacks can be concluded in seconds, thereby making it particularly difficult to avoid the attack or to prevent the attack from succeeding. This is a far cry from text-based vishing attacks, particularly email phishing, in which the victim is given an opportunity to study the content of the text-based attack and time to consider the possibility of the attack being fraudulent. And, unlike text-based phishing, phone numbers are difficult to block and, even if blocked, Internet and mobile phone communications platforms make it easy for fraudsters simply to change phone numbers.

These attributes make it particularly difficult for financial institutions and governments to curb vishing cybercrime and, to date, these entities have yet to find systems or tools to defend effectively against vishing fraud and, currently, the institutional solutions on offer are little more than recommendations for increased vigilance on the part of their customers to avoid becoming vishing fraud victims.

This invention addresses these challenges by providing a system for defending against vishing based on the principle (which the applicant submits is in itself novel and inventive) that a defence against vishing, to be effective, must be a customer-side defence—a defence executed by the intended victim of vishing fraud who, typically, will be a customer of a bank or other financial institution.

A customer-side defence is potentially the most effective form of defence, since a vishing attack is a live attack that targets the customer or victim directly and in the first instance. When a vishing attack occurs, the financial institution has no knowledge of the occurrence of the attack and, self-evidently, is powerless to do anything about whilst the attack was in progress. In the circumstances, the customer is isolated in the fraudster's call once the attack is in progress and exposed, directly and in real time, to the calling fraudster's manipulative social engineering techniques. The financial institution, if it learns of the vishing attack at all, will only know of the attack after the attack has been successfully executed.

### SUMMARY AND DESCRIPTION OF EMBODIMENTS OF THE INVENTION

This invention is directed to a computer-implemented method of defending against a vishing attack in which an attacker makes a voice call to an intended vishing attack victim's mobile phone that has a financial transaction application (app) installed in the mobile phone programmable logic means.

In essence, the method of the invention comprises the steps of directing the mobile phone programmable logic means to treat each voice call incoming to the mobile phone as a trigger to first determine the calling credentials of every incoming voice call and if the calling credentials cannot be determined, directing the mobile phone programmable logic means to monitor for the occurrence of a predetermined vishing procedure executed by means of the mobile phone. If the programmable logic means detects the execution of such a predetermined vishing procedure, the method of the invention directs the mobile phone programmable logic means to notify the financial institution associated with the transaction app of the occurrence of the vishing procedure, to enable the financial institution to implement its predetermined vishing risk and avoidance protocols.

In this specification, unless the context clearly indicates otherwise, the following terms will have the meanings assigned to them in this paragraph:
A “mobile phone” is an Internet-connected mobile communications device, typically a smart phone, that includes programmable logic means comprising a microprocessor-based central processing units (CPU) and supporting electronic circuitry, by means of which computer programs programmed into the programmable logic means are executed.
A “transaction application” or “transaction app” is a computer program, application or app installed in the programmable logic means of a mobile phone by means of which the mobile phone user may interact with and engage a provider of financial services to the user. Typically such transaction apps are supplied to bank customers by banks, in which case the transaction app is generally referred to as a “banking app”.
A “vishing attack” is a voice phishing attempt or action in which an incoming caller, in a voice call to a potential vishing attack victim, manipulates or attempts to manipulate the potential victim into performing actions or divulging confidential information to the incoming caller, typically to allow the incoming caller to gain access to private personal and financial information for purposes of financial fraud.
A “victim” or “vishing attack victim” is a person who is the intended target of a vishing attack.
An “attacker” or “vishing attacker” is a person making an incoming voice call with the intention of perpetrating a vishing attack.
A “voice call” is a phone call made to and conducted by means of the victim's mobile phone, in which the vishing attacker engages in a voice conversation with the intended vishing attack victim. A voice call could be made by the vishing attacker personally or it could be made by means of automated voice technology phone systems, such as interactive voice response (IVR) systems. Automated voice technology phone systems can be scaled up to handle large inbound and outbound call volumes and make it possible for a vishing attacker to engage a large number of potential vishing victims who, in each case, interact with the vishing attacker's computer-operated phone system through the use of voice inputs as well as phone keypad and touch screen inputs. Most potential vishing victims are familiar with IVR systems, which are widely and largely non-fraudulently deployed in business, often to enable mobile phone users to conduct financial transactions, such as banking transactions, mobile purchases and on-line payments. This makes it easier for the vishing attacker to misdirect the vishing victim.
The “calling credentials” of an incoming voice call are data associated with the mobile phone or phone system that is used to make the call incoming to the intended victim's mobile phone. Unless clearly indicated by the context, the only calling credentials required are data pertaining to the phone number of the phone or phone system that is used to make the incoming call which, in the case of mobile phones are data pertaining to the MSISDN stored in the mobile phone SIM (MSISDN—Mobile Station International Subscriber Directory Number—essentially the phone number associated with the SIM).
“Indeterminate calling credentials” of an incoming voice call are calling credentials that the intended vishing attack victim's call-receiving mobile phone is unable to resolve with a view to determining at least the phone number of the phone or phone system that is used to make the incoming call.
A “predetermined vishing procedure” is one of a number of specific vishing procedures used in vishing attacks, including:
   a procedure carried out during or a predetermined time before the occurrence of the voice call being monitored, the procedure comprising processing a One Time Password (OTP) by or by means of the mobile phone;
   a procedure carried out during the occurrence of the voice call being monitored, the procedure comprising opening of the transaction app on the mobile phone and processing, by means of the transaction app, an in-app transaction authorisation request;
   a procedure carried out during the occurrence of the voice call being monitored, the procedure comprising the entry, by means of the mobile phone keypad or touch screen, of a number sequence that matches the number sequence of any one of a number of significant number sequences previously stored in the mobile phone programmable logic means; and
   a procedure carried out during the occurrence of the voice call being monitored, the procedure comprising voice entry of a number sequence that matches the number sequence of any one of a number of significant number sequences previously stored in the mobile phone programmable logic means.

In its most basic form, this invention is directed to a computer-implemented method of defending against a vishing attack in which the calling credentials of the incoming voice call cannot be determined, in which event the call is automatically flagged for monitoring for the occurrence of a vishing procedure.

According to this embodiment of the invention, a computer-implemented method of defending against a vishing attack in which an attacker makes a voice call to an intended vishing attack victim's mobile phone that has a financial transaction application (app) installed in the mobile phone programmable logic means, comprises the steps of, when the mobile phone receives an incoming voice call:
directing the programmable logic means to determine the calling credentials of the incoming voice call;
if the calling credentials of the incoming voice call are indeterminate, directing the programmable logic means to monitor the mobile phone for the occurrence of a predetermined vishing procedure executed by means of the mobile phone; and
if the programmable logic means detects the execution of a predetermined vishing procedure, notifying a financial institution associated with the transaction app of the occurrence of the vishing procedure.

The computer-implemented method of the invention is also applicable to defend against a vishing attack in which an intended vishing attack victim makes a voice call on the intended victim's mobile phone to a potential vishing attacker. To avoid unnecessary duplication, the application of the method of the invention to outgoing voice calls will not be described in any detail because of substantial similarity between the procedures implemented and terminology relating to incoming calls and vishing attacks must, in this specification, be interpreted to apply equally to outgoing calls and vishing attacks occurring on outgoing calls.

In respect of such outgoing voice calls, in which the victim's mobile phone makes an outgoing voice call to the potential attacker, the calling credentials to be determined are those of the outgoing voice call and if the calling credentials of the outgoing voice call are indeterminate (or otherwise considered suspect), the programmable logic means is directed to monitor the mobile phone for the occurrence of a predetermined vishing procedure executed by means of the mobile phone. If the programmable logic means detects the execution of a predetermined vishing procedure, the financial institution is notified of the occurrence of the vishing procedure.

In a second embodiment of the invention, if the calling credentials of the incoming voice call can be determined, the incoming call credentials are compared to a database of known non-suspect call credentials and, if the comparison fails, that is if the incoming call credentials do not match any of the non-suspect call credentials, the incoming call is flagged for monitoring for the occurrence of a vishing procedure.

According to this embodiment of the invention, the computer-implemented method of defending against a vishing attack comprises the steps of, when the mobile phone receives an incoming voice call, directing the programmable logic means to determine the calling credentials of the incoming voice call and, if the calling credentials of the incoming voice call are capable of determination:
directing the device programmable logic means to undertake a data look-up in a caller data store containing previously stored data pertaining to the calling credentials of callers previously identified as permissible callers;
directing the device programmable logic means to compare the calling credentials determined in respect of the incoming voice call to the calling credentials stored in the caller data store;
if the comparison fails, directing the programmable logic means to monitor the mobile phone for the occurrence of a predetermined vishing procedure executed by means of the mobile phone; and
if the programmable logic means detects the execution of a predetermined vishing procedure, notifying a financial institution associated with the transaction app of the occurrence of the vishing procedure.

In this embodiment of the invention, the caller data store may be one or more of a data store constituted by data pertaining to the user's personal contacts stored in the mobile phone programmable logic means and externally derived calling credential data downloaded to the mobile phone programmable logic means or accessed on-line in real time or from time to time.

The user's personal contact data, typically, is stored in a contacts data store in the mobile phone programmable logic means.

The externally derived calling credential data could be institutional calling credential data constituted by the calling credentials of known trusted entities which, typically, would be calling credential data possibly stored in an external calling credential data store by the financial institution whose transaction app is installed on the mobile phone, possibly supplemented by the calling credentials of known trusted entities derived from the mobile network operator associated with the mobile phone.

The method of the invention could be configured, therefore, either to access the external calling credential data store in real time to look up externally derived calling credential data. It might be more efficient, however, to simply download the calling credential data from the external calling credential data store to the mobile phone programmable logic means from time to time, for example as and when regular updates of the transaction app occur.

Mobile network operators recycle numbers that have not been used for some time. Coupled with the fact that vishing fraudsters typically discard SIM cards after use, this enables the inclusion of recycled calling credentials in the externally derived calling credential data store, provided steps are taken to check when a suspicious number was last used. If it was last used longer than the time it takes the network to recycle a number, the number will be considered a new unknown number. This will ensure that recycled numbers are not unfairly prejudiced.

To be comprehensive, the computer-implemented method of the invention could also make use of “unsafe” calling credential data, which would be data pertaining to calling credentials previously flagged as suspect and which would automatically trigger the monitoring steps of the method.

The invention includes a data processing system comprising means for carrying out the methods outlined above.

In addition, the invention includes first and second interacting computer programs wherein the first computer program is an electronic transaction application (app) and the second computer program is an early warning application (app) configured, when executed by the mobile phone programmable logic means, causes the programmable logic means to carry out the methods outlined above.

In a preferred embodiment of this invention, the early warning app is simply a module of the electronic transaction app. The early warning app is programmed to cooperate with the electronic transaction/banking app of the financial institution and if any aspects of the early warning app are to be displayed to the user on the device GUI, those aspects are preferably configured with the look and feel of the banking app to enhance familiarity and ease-of-use.

The invention does not make use of voice recognition or voice recording and therefore does not “listen in” or record user calls. However, a degree of voice recognition is nevertheless implemented in respect of monitoring for the vishing procedure consisting of voice entry of number sequences.

In preparation for such a monitoring process, the process of installing the early warning app on the mobile phone preferably includes an app registration process that includes voice training in which the mobile phone programmable logic means is trained to recognise when the user. In such a training process, for example, the user could be required to read a set of numbers considered sufficient to recognise any sequence of numbers, whichever way the user pronounces the sequence of numbers.

This training is used in monitoring for the vishing procedure comprising voice entry of a number sequence that matches the number sequence of any one of a number of significant number sequences previously stored in the mobile phone programmable logic means. The significant number sequences, typically, consist of the user's credit card numbers, bank account numbers and PINs. The early warning app is programmed to flag it as a vishing procedure if three or more correctly sequenced numbers corresponding to any significant number sequence is either entered or spoken while the mobile phone programmable logic means is monitoring the mobile phone for the occurrence of any such a vishing procedure executed by means of the mobile phone.

In all instances, when the financial institution is alerted to the occurrence of a vishing attack, this will enable the financial institution to implement its own measures which, typically, will comprise of a number of escalating risk protocols, ranging from alerting the customer to implementing measures to prevent the electronic transaction from proceeding. In this regard, financial institutions have standard protocols to deal with potential and actual interference with their customers' financial transactions and electronic financial transactions in particular. These standard protocols would require little modification to serve as appropriate preventative measures for use with the electronic transaction vishing defence method of the invention.

What is claimed is:

1-10. (canceled)

11. A computer-implemented method of defending against a vishing attack in which an attacker makes a voice call to an intended vishing attack victim's mobile phone that has a financial transaction application (app) installed in the mobile phone programmable logic means, comprises the steps of, when the mobile phone receives an incoming voice call:
directing the programmable logic means to determine the calling credentials of the incoming voice call;
if the calling credentials of the incoming voice call are indeterminate, directing the programmable logic means to monitor the mobile phone for the occurrence of a predetermined vishing procedure executed by means of the mobile phone; and
If the programmable logic means detects the execution of a predetermined vishing procedure, notifying a financial institution associated with the transaction app of the occurrence of the vishing procedure.

12. The computer-implemented method of claim 11 which comprises the steps of, when the mobile phone receives an incoming voice call, directing the programmable logic means to determine the calling credentials of the incoming voice call and, if the calling credentials of the incoming voice call are capable of determination:
directing the device programmable logic means to undertake a data look-up in a caller data store containing previously stored data pertaining to the calling credentials of callers previously identified as permissible callers;
directing the device programmable logic means to compare the calling credentials determined in respect of the incoming voice call to the calling credentials stored in the caller data store;
if the comparison fails, directing the programmable logic means to monitor the mobile phone for the occurrence of a predetermined vishing procedure executed by means of the mobile phone; and
if the programmable logic means detects the execution of a predetermined vishing procedure, notifying a financial institution associated with the transaction app of the occurrence of the vishing procedure.

13. The computer-implemented method of claim 12 wherein the caller data store is constituted by data pertaining to the user's personal contacts stored in the mobile phone programmable logic means.

14. The computer-implemented method of claim 12 wherein the caller data store is constituted by data pertaining to the user's personal contacts stored in the mobile phone programmable logic means and externally derived calling credential data downloaded to the mobile phone programmable logic means or accessed on-line in real time or from time to time.

15. A data processing system comprising means for carrying out the method of claim 11.

16. A data processing system comprising means for carrying out the method of claim 12.

17. A computer program comprising instructions which, when the program is executed in programmable logic means in a mobile phone, cause the mobile phone to carry out the method of claim 11.

18. A computer program comprising instructions which, when the program is executed in programmable logic means in a mobile phone, cause the mobile phone to carry out the method of claim 12.

19. The computer program of claim 17 in which the computer program comprises first and second interacting computer programs wherein the first computer program is an electronic transaction application (app) and the second computer program is an early warning application (app) configured, when executed by the mobile phone programmable logic means, causes the programmable logic means to carry out the computer-implemented method.

20. The computer program of claim 19 in which the early warning app is a module of the electronic transaction app, the early warning app module being programmed to cooperate with the electronic transaction app.
